(19) United States
(12) Patent Application Publication
(10) Pub. No.: US 2014/0270887 A1
(43) Pub. Date: Sep. 18, 2014

(54) GLUE STICK DISPENSER WITH ANGLED TIP

(71) Applicants: Shawn HEIPP, Dublin, OH (US); Louis A. Farchione, III, Columbus, OH (US)

(72) Inventors: Shawn HEIPP, Dublin, OH (US); Louis A. Farchione, III, Columbus, OH (US)

(21) Appl. No.: 13/845,718

(22) Filed: Mar. 18, 2013

(51) Int. Cl. B43M 11/06; B05C 17/01

(52) U.S. Cl. CPC B43M 11/06; B05C 17/0133
USPC 401/6; 401/55; 401/75

(57) ABSTRACT

A glue stick dispenser that includes an elongated tubular body adapted to receive a glue stick, wherein the elongated tubular body is substantially triangular in cross-section, and wherein the triangular shape of the body is operative to encourage a user of the dispenser to hold the dispenser in a predetermined manner; a tip attached to or formed integrally with one end of the elongated tubular body, wherein the angle of the terminal portion of the tip, when oriented substantially parallel to a horizontal surface, positions the elongated tubular body at a predetermined angle relative to the horizontal surface; and a mechanism for advancing the glue stick through the elongated tubular body and out of the angled tip.

### BACKGROUND OF THE INVENTION

The described invention relates in general to a hand-held dispenser for glue stick products and the like, and more specifically to a glue stick dispenser that includes a number of unique features making the dispenser particularly advantageous for use by children.

Teaching a child how to correctly hold a pencil is important for preventing the development of a poor pencil grip, which can lead to poor writing habits and other problems. As they begin to write, many children grip the pencil too tightly, which makes writing smoothly and correctly difficult. To avoid these issues, a common method for teaching a child to write involves the so-called “tripod grip” or “tripod grasp” for holding a pencil or pen. Teaching the tripod grip typically involves placing the pencil in front of the child with the tip pointing toward the child; and asking the child to grasp the pencil in his or her right or left hand with the tips of his or her thumb, index, and middle finger. Learning the tripod grip prevents physical problems of the hand and wrist and ultimately allows the child to write easily as their skills and abilities develop. The proper grip also facilitates drawing, painting, and other artistic activities, such as arts and crafts involving glue or other materials. Because teaching a child the proper grip for a pencil, pen, and/or certain types of glue dispensers is recognized to be important for a child's development, there is an ongoing need for writing implements and glue dispensers that encourage proper gripping techniques and proper techniques for using such items.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a first dispenser for use with a manually-operated glue stick is provided. This dispenser includes an elongated tubular body, wherein the elongated tubular body is adapted to receive a glue stick, wherein the elongated tubular body is substantially triangular in cross-section, and wherein the triangular shape of the body is operative to encourage a user of the dispenser to hold the dispenser in a predetermined manner; a tip attached to or formed integrally with one end of the elongated tubular body, wherein the angle of the terminal portion of the tip, when oriented substantially parallel to a horizontal surface, positions the elongated tubular body at a predetermined angle relative to the horizontal surface; and a mechanism for advancing the glue stick through the elongated tubular body and out of the angled tip.

In accordance with another aspect of the present invention, a second dispenser for use with a manually-operated glue stick is provided. This dispenser includes an elongated tubular body, wherein the elongated tubular body is adapted to receive a glue stick, wherein the elongated tubular body is substantially triangular in cross-section, and wherein the triangular shape of the body is operative to encourage a user of the dispenser to hold the dispenser in a predetermined manner; a tip attached to or formed integrally with one end of the elongated tubular body, wherein the angle of the terminal portion of the tip, when oriented substantially parallel to a horizontal surface, positions the elongated tubular body at a predetermined angle relative to the horizontal surface; and a mechanism for advancing the glue stick through the elongated tubular body and out of the angled tip, wherein the mechanism further includes a rotatable screw and an elevator apparatus mechanically coupled with the rotatable screw for advancing the glue stick when the screw portion is rotated.

In yet another aspect of this invention, a third dispenser for use with a manually-operated glue stick is provided. This dispenser includes an elongated tubular body, wherein the elongated tubular body is adapted to receive a glue stick, wherein the elongated tubular body is substantially triangular in cross-section, and wherein the triangular shape of the body is operative to encourage a user of the dispenser to hold the dispenser in a predetermined manner; a tip attached to or formed integrally with one end of the elongated tubular body, wherein the angle of the terminal portion of the tip, when oriented substantially parallel to a horizontal surface, positions the elongated tubular body at a predetermined angle relative to the horizontal surface; a mechanism for advancing the glue stick through the elongated tubular body and out of the angled tip, wherein the mechanism further includes a rotatable screw and an elevator apparatus mechanically coupled with the rotatable screw for advancing the glue stick when the screw portion is rotated; and a cap for covering and enclosing the tip, wherein the cap is triangular in cross-section and further includes a lip formed circumferentially around the cap for facilitating removal thereof from the elongated tubular body.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1A is a perspective view of an assembled glue stick dispenser in accordance with an exemplary embodiment of the present invention;

FIG. 1B is an exploded perspective view of the glue stick dispenser of FIG. 1;

FIG. 2A is a side view of the cap component of the glue stick dispenser of FIG. 1;

FIG. 2B is a cross-sectional side view of the cap component of the glue stick dispenser of FIG. 1;

FIG. 2C is a top view of the cap component of the glue stick dispenser of FIG. 1;

FIG. 2D is a bottom view of the cap component of the glue stick dispenser of FIG. 1;

FIG. 3A is a side view of the tubular body component of the glue stick dispenser of FIG. 1;

FIG. 3B is a cross-sectional side view of the tubular body component of the glue stick dispenser of FIG. 1;

FIG. 3C is a top view of the tubular body component of the glue stick dispenser of FIG. 1;

FIG. 3D is a bottom view of the tubular body component of the glue stick dispenser of FIG. 1;

FIG. 4A is a side view of the elevator component of the glue stick dispenser of FIG. 1;

FIG. 4B is a cross-sectional side view of the elevator component of the glue stick dispenser of FIG. 1;

FIG. 4C is a top view of the elevator component of the glue stick dispenser of FIG. 1;

FIG. 4D is a bottom view of the elevator component of the glue stick dispenser of FIG. 1;

FIG. 5A is a side view of the screw component of the glue stick dispenser of FIG. 1;

FIG. 5B is a cross-sectional side view of the screw component of the glue stick dispenser of FIG. 1;

FIG. 5C is a top view of the screw component of the glue stick dispenser of FIG. 1;

FIG. 5D is a bottom view of the screw component of the glue stick dispenser of FIG. 1; and

FIG. 6 is a side view of an exemplary embodiment of the glue stick dispenser of the present invention illustrating the angle of the dispenser relative to a horizontal surface when the dispenser is in use.

### DETAILED DESCRIPTION OF THE INVENTION

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention. With reference now to the Figures, one or more specific embodiments of this invention shall be described in greater detail.

As previously indicated, and with reference to the Figures, the present invention relates in general to a hand-held dispenser for glue stick products and the like, and more specifically to a glue stick dispenser that includes a number of unique features making the dispenser particularly advantageous for use by children. As best shown in FIGS. 1A-B, glue stick dispenser 10 includes cap 20, elongated tubular body 40, elevator 60, and screw 80. Each of these components is substantially triangular in cross-section (side-to side) and this unique geometry encourages a user of dispenser 10 to hold the device in a manner conducive to proper writing or writing-like activities such as using a glue stick for arts and crafts.

As shown in FIGS. 2A-D, cap 20 includes body 22, circumferential lip 24, and top portion 26. Cap 20 covers and encloses the top portion of dispenser 10 and lip 24 facilitates the removal of cap 20 from the dispenser. In some embodiments, cap 20 also includes at least one tab 23 formed on the inner surface of the cap (see FIG. 2D). As shown in FIGS. 3A-D, elongated tubular body 40 includes base 42, middle portion 44, and triangular tip 46, which further includes front portion 48, which is wider than pointed rear portion 50. In some embodiments, body 40 also includes at least one recessed area 45 formed in the exterior portion of the body. These recessed portions cooperate with tabs 23 formed in cap 20 to provide a locking mechanism for securing cap 20 to body 40 in a releasable manner. Base 42 further includes a recessed region having aperture 41 formed therein (see FIG. 3B). As shown in FIGS. 4A-D, elevator 60, which is positioned inside body 40, includes base 62 and hollow body 64. A threaded portion 61 is formed in base 62 and extends upward into hollow body 64 (see FIG. 4B). As shown in FIGS. 5A-D, screw 80 includes rotatable knob/handle 82, base 84, and threaded shaft 86. When assembled, base 84 and threaded shaft 86 are mechanically coupled to threaded portion 61 in elevator 60, which extends through aperture 41 in elongated tubular body 40. A solid or semi-sold glue stick product is deposited around threaded shaft 86 and the bottom portion of the glue stick rests in hollow body 64. As knob 82 is rotated, elevator 60 moves upward on threaded shaft 86 and advances the glue stick through elongated tubular body 40 and out of tip 46.

As shown in FIG. 6, the angle of the terminal portion of tip 46, when oriented substantially parallel to a horizontal surface, positions elongated tubular body 40 at a predetermined angle relative to the horizontal surface. This placement of the dispenser when in use further facilitates proper hand and finger position for writing, crafting, or other purposes. In FIG. 6, the predetermined angle is about 60° although other angles are possible. In an exemplary embodiment of this invention, all of the external and internal components are manufactured from plastic, polymer, combinations thereof, or similar materials.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A dispenser for use with a manually-operated glue stick, comprising:
(a) an elongated tubular body, wherein the elongated tubular body is adapted to receive a glue stick, wherein the elongated tubular body is substantially triangular in cross-section, and wherein the triangular shape of the body is operative to encourage a user of the dispenser to hold the dispenser in a predetermined manner;
(b) a tip attached to or formed integrally with one end of the elongated tubular body, wherein the angle of the terminal portion of the tip, when oriented substantially parallel to a horizontal surface, positions the elongated tubular body at a predetermined angle relative to the horizontal surface; and
(c) a mechanism for advancing the glue stick through the elongated tubular body and out of the angled tip.

2. The dispenser of claim 1, further comprising a cap for covering and enclosing the tip, wherein the cap is triangular in cross-section and further includes a lip formed circumferentially around the cap for facilitating removal thereof from the elongated tubular body.

3. The dispenser of claim 1, wherein the glue stick is a solid glue stick or a semi-solid glue stick.

4. The dispenser of claim 1, wherein the predetermined manner for holding the dispenser is the tripod grip.

5. The dispenser of claim 1, wherein the predetermined angle of the elongated tubular body relative to the horizontal surface is about 60°.

6. The dispenser of claim 1, wherein the mechanism for advancing the glue stick through the elongated tubular body further includes a rotatable screw and an elevator apparatus mechanically coupled with the rotatable screw for advancing the glue stick when the screw portion is rotated.

7. The dispenser of claim 1, wherein the mechanism for advancing the glue stick through the elongated tubular body is integrated into and cooperates with the elongated tubular body.

8. A dispenser for use with a manually-operated glue stick, comprising:
(a) an elongated tubular body, wherein the elongated tubular body is adapted to receive a glue stick, wherein the elongated tubular body is substantially triangular in cross-section, and wherein the triangular shape of the body is operative to encourage a user of the dispenser to hold the dispenser in a predetermined manner;
(b) a tip attached to or formed integrally with one end of the elongated tubular body, wherein the angle of the terminal portion of the tip, when oriented substantially parallel to a horizontal surface, positions the elongated tubular body at a predetermined angle relative to the horizontal surface; and
(c) a mechanism for advancing the glue stick through the elongated tubular body and out of the angled tip, wherein the mechanism further includes a rotatable screw and an elevator apparatus mechanically coupled with the rotatable screw for advancing the glue stick when the screw portion is rotated.

9. The dispenser of claim 8, further comprising a cap for covering and enclosing the tip, wherein the cap is triangular in cross-section and further includes a lip formed circumferentially around the cap for facilitating removal thereof from the elongated tubular body.

10. The dispenser of claim 8, wherein the glue stick is a solid glue stick or a semi-solid glue stick.

11. The dispenser of claim 8, wherein the predetermined manner for holding the dispenser is the tripod grip.

12. The dispenser of claim 8, wherein the predetermined angle of the elongated tubular body relative to the horizontal surface is about 60°.

13. The dispenser of claim 8, wherein the mechanism for advancing the glue stick through the elongated tubular body is integrated into and cooperates with the elongated tubular body.

14. The dispenser of claim 8, wherein the components of the dispenser are plastic.

15. A dispenser for use with a manually-operated glue stick, comprising:
(a) an elongated tubular body, wherein the elongated tubular body is adapted to receive a glue stick, wherein the elongated tubular body is substantially triangular in cross-section, and wherein the triangular shape of the body is operative to encourage a user of the dispenser to hold the dispenser in a predetermined manner;
(b) a tip attached to or formed integrally with one end of the elongated tubular body, wherein the angle of the terminal portion of the tip, when oriented substantially parallel to a horizontal surface, positions the elongated tubular body at a predetermined angle relative to the horizontal surface;
(c) a mechanism for advancing the glue stick through the elongated tubular body and out of the angled tip, wherein the mechanism further includes a rotatable screw and an elevator apparatus mechanically coupled with the rotatable screw for advancing the glue stick when the screw portion is rotated; and
(d) a cap for covering and enclosing the tip, wherein the cap is triangular in cross-section and further includes a lip formed circumferentially around the cap for facilitating removal thereof from the elongated tubular body.

16. The dispenser of claim 15, wherein the glue stick is a solid glue stick or a semi-solid glue stick.

17. The dispenser of claim 15, wherein the predetermined manner for holding the dispenser is the tripod grip.

18. The dispenser of claim 15, wherein the predetermined angle of the elongated tubular body relative to the horizontal surface is about 60°.

19. The dispenser of claim 15, wherein the mechanism for advancing the glue stick through the elongated tubular body is integrated into and cooperates with the elongated tubular body.

20. The dispenser of claim 15, wherein the tip further includes at least one recessed area formed therein, wherein the cap further includes at least one tab formed thereon, and wherein the at least one recessed area cooperates with the at least one tab to secure the cap to the body in a releasable manner.
